(19) United States
(12) Patent Application Publication
(10) Pub. No.: US 2007/0043112 A1
(43) Pub. Date: Feb. 22, 2007

(54) Use of non-opiates for the potentation of opiates

(76) Inventors: John Brew, Essex (GB); Robin Mark Bannister, Essex (GB); Andrew Douglas Baxter, Essex (GB); Alan Rothaul, Essex (GB); Michael Harvey Lyne, Essex (GB)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 10/575,913

(22) PCT Filed: Oct. 21, 2004
(86) PCT No.: PCT/GB04/04446

§ 371 Date: Nov. 16, 2006

(30) Foreign Application Priority Data
Oct. 21, 2003 (GB) 0324578.4
Mar. 24, 2004 (GB) 0406657.7

(51) Int. Cl. A01N 37/00

(52) U.S. Cl. 514/510

(57) ABSTRACT

A non-opioid analgesic is used for the treatment of intermittent or episodic pain experienced by a patient undergoing chronic pain treatment with an opioid analgesic.

### FIELD OF THE INVENTION

The present invention relates to the use of non-opiates for the treatment of pain, and in the potentiation of opiates, to boost analgesia.

### BACKGROUND OF THE INVENTION

Patients suffering from chronic benign pain and/or cancer pain are often treated with opiates/opioids which are often administered in a controlled release manner. However, from time to time, the analgesic effect cover is insufficient and the patient experiences painful episodes.

Such intermittent, uncontrollable episodes (breakthroughs) are found in chronic benign pain states which can be categorised as musculoskeletal, visceral and headache pain, and include conditions such as osteoarthritis, chronic pancreatitis and chronic migraine. Breakthrough pain is also found in cancer pain conditions associated with the malignant growth of tumours both primary and metastatic in nature. Such conditions are thought to be associated with either pressure on normal tissue (invasion) or the release of pro-nociceptive mediators in and around the tumour.

Cancer breakthrough pain (CBP) is a particular example of episodic pain, and is characterised by short-lasting severe pain episodes superimposed upon background pain treated with standard analgesia, typically seen in patients with advanced-stage cancer. The majority of patients with CBP present with a mixed nociceptive-neuropathic pain, with a subpopulation (which is well recognised) having predominantly neuropathic CBP. This neuropathic element is refractive to conventional opioid-derived analgesia, undermining overall therapeutic effectiveness and patient quality of life in an already under-diagnosed and under-treated condition.

Tumours that metastasise to the bone, notably those derived from lung, breast and prostate cancer, are likely to generate episodes of CBP. The aetiological composition of CBP is mostly nociceptive and/or visceral, as a result of the pressure exerted by the advancing tumour. The neuropathic element is mostly likely explained as a result of tumour-related nerve compression and/or destruction. However, there are other causes such as the action of pro-inflammatory agents secreted by cancerous tissue in direct proximity to the nerve.

The prevalence of neuropathic-related CBP ranges from 10-26% of breakthrough episodes. Zeppetella et al (2001) surveyed UK CBP patients and found that 10% of CBP could be classified as neuropathic, whilst a recent survey by Portenoy et al (2000) suggested a higher figure, of around 26%.

First-line treatments for CBP are dependent upon the physician's assessment of the type and severity of pain in which the patient is suffering. Pharmacological treatment for neuropathic cancer pain consists of empirical titration of anticonvulsants, notably gabapentin, or tricyclic antidepressants, in common with the treatment of benign forms of neuropathic pain.

Current treatments for neuropathic-related CBP involve using rapidly acting supplementary opiates. These are not always seen as desirable, due to problems with illicit diversion and in some cases accidental usage. In addition, they are often administered in such a way as to delay their onset of action, resulting in a shortfall in the analgesia required by the patient and/or analgesia prolonged unnecessarily beyond the duration of the breakthrough episode. Therefore, a rapid and efficacious treatment remains an unmet medical need.

NMDA NR2B specific antagonists, exemplified by ifenprodil, are known to potentiate opiates (Bernardi et al, 1996). The combination of the side-effects associated with the co-administration of NMDA antagonists and opiates (Hoffman et al, Pharmacol Biochem Behav. 2003) produces significantly more respiratory depression, and possibly more emesis and mental clouding, than either agent given alone.

CCK receptor antagonists such as proglumide have been demonstrated to reverse tolerance to opiates, reducing the dose of opiate required to produce analgesia (Kellstein et al, Pain; 1991). Consequently, proglumide has been demonstrated to boost opiate analgesia, meaning that a markedly reduced dose of opioid is required to achieve the same level of analgesia. This has been shown to occur, without any potentiation in respiratory depression (U.S. Pat. No. 4,576,951) or any effect on the development of opiate dependence (Paneria et al., Brain Research; 1987).

The pharmacology of proglumide is mixed CCK_{A} (gastrin) and CCK_{B} antagonism, its anti-ulceration action being via the inhibition of the CCK_{A} receptor. Antagonism at the CCK_{B} receptor has thus far been unexploited and is known to be involved in the development of tolerance to morphine analgesia (Watkins et al, Science; 1984). Proglumide when given by the oral route is known to induce headache as its major side-effect.

Noradrenaline/serotonin reuptake inhibitors have been shown to be opiate potentiators (Larsen and Arnt, Acta Pharmacol Toxicol; 1984). They are exemplified by desipramine, a classical antidepressant, and nefopam which is a non-opiate analgesic drug. Such compounds have a number of side-effects at oral therapeutic doses, which include cardiovascular abnormalities, restlessness, insomnia, ataxia, dry mouth and emesis.

Adrenergic stimulating agents include agents which stimulate alpha₂ adrenoceptors and potentiate opiates. Alpha adrenoceptor agonists are exemplified by clonidine. Clonidine is a strong non-opiate analgesic which is often given intrathecally at analgesic doses to avoid its poor side-effect profile which includes hypotension, emesis, weight gain, nervousness and fatigue. Beta adrenoceptor agonists are exemplified by salbutamol. Salbutamol is a bronchodilator which is given via the pulmonary route by dry powder inhaler. Its side-effects are typical of the beta adrenoceptor agonists, i.e. tremor, tachycardia, tension, headaches and peripheral vasodilation.

COX inhibitors are generally known to potentiate the effects of opiates and are often used in combination with weak opiates for the treatment of moderate pain (cocodamol and coproxamol). Diclofenac is an example of a mixed COX inhibitor. Therapeutic doses of diclofenac have side-effects include gastric ulceration, abdominal cramps, constipation and dizziness.

### SUMMARY OF THE INVENTION

The present invention is a new use for non-opiate analgesics in the treatment of episodic pain, and in particular of breakthrough pain associated with chronic benign pain or cancer pain states. The dose of non-opiate can be low enough not to induce side-effects often associated with either the non-opiate alone or the combination of non-opiate and opiate. The non-opiate is preferably administered via a route which avoids first-pass metabolism.

In particular, intranasal or sublingual administration of non-opiate, opiate potentiators allows lower doses of the potentiators than those used for oral administration. This has the advantage of minimising the side-effects commonly attributed to the drugs in question.

As breakthrough pain requires immediate relief, clinicians and patients alike would find it desirable to administer a dose of the non-opiate through the nasal or sublingual delivery route. The effect via such a route is rapid, and follows a time course similar to that seen with intravenous administration and can provide an improved treatment over those currently available. In addition, this route avoids first-pass metabolism, but also allows quicker penetration to the CNS, which may allow the administration of lower doses than are needed for other indications. This reduces the side-effects of the non-opiate.

### DESCRIPTION OF THE INVENTION

This invention involves the use of non-opiates (which may be described herein as potentiators). They can typically be used in treatment where an opiate such as morphine, and of which many other examples are known to those skilled in the art, is being used.

Non-opiates suitable for use in the present invention include NMDA antagonists specific for the NR2B subunit. These are exemplified by ifenprodil, felbamate and eliprodil.

Suitable non-opiates also include CCK antagonists. These are exemplified by proglumide, devazipide and loxiglumide.

Further suitable non-opiates include biogenic amine reuptake inhibitors (antidepressants, neuroleptics and analgesics), which inhibit reuptake of noradrenaline and serotonin. Antidepressants include agents such as adrafinil, amfebutamone, amitriptyline, amitriptylinoxide, amixetrine, amoxapine, benmoxin, binedaline, butriptyline, caroxazone, carpipramine, citalopram, clomipramine, desipramine, dibenzapine, dimetacrine, dosulapine, doxepine, etoperidone, fenpentadiol, fipexide, fluoxetine, fluvoxamine, imipramine, indalpine, indeloxacine, iproniazid, isocaroxazid, lofepramine, maprotiline, medifoxamine, melitracen, metapramine, mianserin, milnacipran, minaprine, mirtazapine, moclobemide, nefazodone, nialamide, nomifensine, nortriptyline, noxiptiline, opipramol, oxaflozane, paroxetine, pheneizine, protirelin, protriptyine, quinupramine, reboxetine, sertraline, setiptiline, sibutramine, sulpiride, sultopride, tandospirone, tofenacin, toloxatone, tranylcypromine, trazodone, trimipramine, venlafaxine, viloxazine and zimeladine. Analgesic reuptake inhibitors include agents such as tramadol, duloxetine, nefopam and venlafaxine. Neuroleptics include agents such as acepromazine, aceprometazine, acepromazine, aceprometazine, acetophenazine, alizapride, benactyzine, benperidol, bromperidol, butaperazine, clopenthixol, chlorpromazine, chlorprothixene, carfenazine, clozapine, cyamemazine, deserpidine, dixyrazine, droperidol, fluanisone, flupentixol, fluphenazine, fluspirilene, haloperidol, homofenazine, levomepromazine, loxapine, mosapramine, moperone, melperone, oxypertine, pipamperone, pimozide, perphenazine, perimetazine, periciazine, penfluridol, pecazine, pipotiazine, piperacetazine, prothipendyl, promazine, profenamine, sulforidazine, spiperone, timiperone, tiapride, thioridazine, thioproperazine, thiopropazate, tiotixene, trifluoperazine, trifluperidol, triflupromazine and zotepine.

Non-opiate potentiators of opiates also include agents which potentiate the noradrenergic system by acting as beta₂ adrenoceptor agonists. Agents which stimulate beta₂ adrenoceptors include drugs such as albuterol, bambuterol, bitolterol, broxaterol, carbuterol, clenbuterol, eformoterol, fenoterol, folmoterol, foradil, isoproterenol, metaproterenol, pirbuterol, procaterol, salbutamol, salmeterol, reproterol, rimiterol, terbutaline, tretoquinol and tulobuterol.

Non-opiate potentiators of opiates also include agents which potentiate the noradrenergic system by acting as alpha₂ adrenoceptors agonists. Agents which stimulate alpha2 adrenoceptors include drugs such as brimonidine, clonidine, medetomidine, moxonidine, rilmenidine and tizanidine.

Non-opiate potentiators of opiates also include cyclooxygenase (COX) inhibitors, which include non-selective COX inhibitors, selective COX-2 inhibitors such as celecoxib, selective COX-3 inhibitors such as paracetamol, COX inhibitors linked to NO donors and dual action COX and lipoxygenase (LOX) inhibitors. The use of these compounds can be free of GI side-effects commonly associated with these agents delivered orally.

COX inhibitors are exemplified by agents such as aceclofenac, acemetacin, alcofenac, alminoprofen, aloxipirin, amfenac, aminophenazone, antraphenine, aspirin, azapropazone, benorilate, benoxaprofen, benzydamine, butibufen, chlorthenoxacine, choline salicylate, chlometacin, dexketoprofen, diclofenac, diflunisal, emorfazone, epirizole, etodolac, feclobuzone, felbinac, fenbufen, fenclofenac, flurbiprofen, glafenine, hydroxylethyl salicylate, ibuprofen, indometacin, indoprofen, ketoprofen, ketorolac, lactyl phenetidin, loxoprofen, mefenamic acid, metamizole, mofebutazone, mofezolac, nabumetone, naproxen, nifenazone, oxametacin, phenacetin, pipebuzone, pranoprofen, propyphenazone, proquazone, salicylamide, salsalate, sulindac, suprofen, tiaramide, tinoridine, tolfenamic acid and zomepirac.

Selective COX-2 inhibitors are exemplified by agents such as celecoxib, etoricoxib, lumiracoxib, meloxicam, parecoxib, rofecoxib, tilmacoxib and valdecoxib. Selective COX-3 inhibitors are exemplified by agents such as antipyrine, dipyrone, paracetamol and phenacetin. COX inhibitors linked to NO donors are exemplified by agents such as nitroflurbiprofen, nitronaproxen and nitrofenac. Dual action COX and lipoxygenase (LOX) inhibitors are exemplified by agents such as licofelone and ketoprofen.

A compound for use in the invention may be in any suitable form, e.g. as a salt. Further, if the compound is chiral, any enantiomeric form, or a racemic or non-racemic mixture, may be used.

A preferred non-opiate for use in the present invention is ifenprodil, e.g. as a single enantiomer such as (−)-threo-ifenprodil, preferably as the citrate or another salt form. Intranasal dosing is a preferred route of administration of ifenprodil for the potentiation of opiates. An intranasal formulation of ifenprodil is described in WO03/092689 and in another PCT application filed on 21 Oct. 2004 in the name of Arakis Ltd., claiming priority from British Patent Application No. 0324583.4.

Another preferred route of administration is sublingual. A suitable formulation for this purpose may contain components known to those skilled in the art.

Another preferred agent is nefopam; see WO03/105833 for general information and an example. The contents of that publication and others referenced herein are incorporated by reference.

The following Example illustrates the invention, in conjunction with the accompanying drawing.

### DESCRIPTION OF THE DRAWING

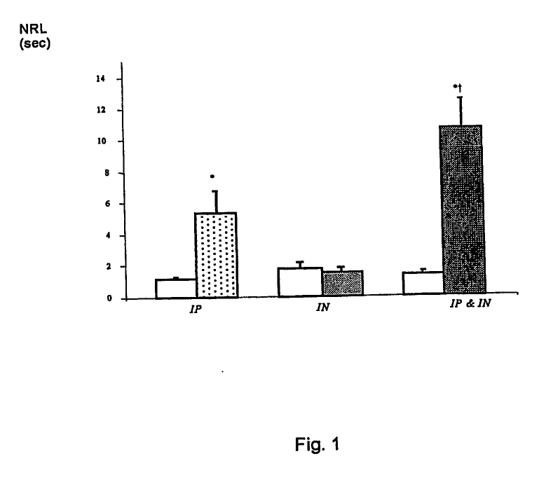

The drawing (FIG. 1) is a bar chart showing nociceptive reaction latency for different routes of administration of drugs.

### EXAMPLE

In this Example, the potentiation of opiate analgesia has been demonstrated, by a nasally administered non-opiate agent, in the rat tail flick assay. FIG. 1 shows the results, and the significant potentiation of morphine analgesia with a non-analgesic dose of the non-opiate agent.

In FIG. 1, results are expressed as mean±sem for 6 experiments, which are (from left to right): vehicle, morphine (6 mg/kg), vehicle, ifenprodil (1 mg/rat), vehicle IN+vehicle IP, and ifenprodil IN (1 mg/rat)+morphine IP (6 mg/kg).
vehicle: 90% saline 10% propylene glycol
vehicle and morphine were given intraperitoneally 30 min. before the test
vehicle and ifenprodil were given intranasally 30 min. before the test
n=10 rats per group
student's T test: * indicates a significant difference in comparison to the vehicle group for P<0.05
student's T test: † indicates a significant difference in comparison to the morphine group for P<0.05

These results indicate that ifenprodil can be used in the treatment of breakthrough pain. In particular, the data show that ifenprodil potentiates morphine when administered intranasally and therefore has the ideal characteristics to be used in the treatment of breakthrough pain (low pain, rapid onset, low or no sideeffects).

1. A method for the treatment of intermittent or episodic pain experienced by a patient undergoing chronic pain treatment with an opioid analgesic wherein said method comprises administering to the patient a non-opioid analgesic.

2. The method according to claim 1, wherein the pain is chronic benign pain.

3. The method according to claim 2, wherein the pain is related to a musculoskeletal, visceral or headache condition.

4. The method according to claim 3, wherein the condition is osteoarthritis, rheumatoid arthritis, chronic back pain, chronic pancreatitis or chronic migraine.

5. The method according to claim 1, wherein the pain is breakthrough pain in cancer.

6. The method according to claim 5, wherein the cancer breakthough pain is primarily neuropathic.

7. The method according to claim 1, wherein the non-opioid analgesic is a potentiatior of the opioid analgesic.

8. The method according to claim 1, wherein the non-opioid analgesic is selected from antagonists of NMDA, CCK, substance P or Neurokinin, compounds that cause uptake blockade, agonists of alpha₂ or beta₂ adrenoceptors, and COX inhibitors.

9. The method according to claim 1, wherein the non-opioid analgesic is selected from clenbuterol, proglumide, devazepide, ifenprodil, nefopam, tramadol, duloxetine and venlafaxine.

10. The method, according to claim 1, where the administration is done via a route that avoids first-pass metabolism.

11. The method according to claim 10, wherein the route is intranasal.

12. The method according to claim 10, wherein the route is sublingual.

13. The method according to claim 10, wherein the route is pulmonary.

14. A product comprising an opioid analgesic and a non-opioid analgesic, as a combined preparation for simultaneous, separate or sequential use in the treatment of chronic pain including intermittent or episodic pain.

15. The product according to claim 14, wherein the non-opioid analgesic is a potentiatior of the opioid analgesic.

16. The product according to claim 14, wherein the non-opioid analgesis is selected from antagonists of NMDA, CCK, substance P or Neurokinin, compounds that cause uptake blockade, agonists of alpha₂ or beta₂ adrenoceptors, and COX inhibitors.

17. The product according to claim 14, wherein the non-opioid analgesic is selected from clenbuterol, proglumide, devazepide, ifenprodil, nefopam, tramadol, duloxetine and venalfaxine.
